(19) United States
(12) Patent Application Publication
(10) Pub. No.: US 2004/0116242 A1
(43) Pub. Date: Jun. 17, 2004

(54) Roller bearing

(75) Inventors: Noriko Uchiyama, Kanagawa (JP); Takeshi Yamamoto, Kanagawa (JP); Yoshiteru Yasuda, Yokohama (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/704,711

(22) Filed: Nov. 12, 2003

(30) Foreign Application Priority Data
Dec. 12, 2002 (JP) 2002-361099
Mar. 13, 2003 (JP) 2003-067807
Aug. 7, 2003 (JP) 2003-206425

(51) Int. Cl. F16H 15/38

(52) U.S. Cl. 476/46

(57) ABSTRACT

A roller bearing is provided which comprises a pair of rings at least one of which has a rib with a rib face, and a plurality of rollers interposed between the rings and each having a roller end face in sliding contact with the rib face, wherein at least one of the rib face and the roller end face has a surface hardness HV of 750 or more.

### BACKGROUND OF THE INVENTION

The present invention relates to a roller bearing, particularly of the kind for use in a toroidal CVT (Continuously Variable Transmission) and in traction oil.

As is well known, a roller bearing includes a plurality of rollers such as cylindrical rollers, tapered rollers and spherical rollers interposed between inner and outer rings and is used in rotating portions of various machines. For example, in a vehicle differential, a tapered roller bearing is interposed between a housing and a differential casing for rotatably supporting the differential casing upon the housing as disclosed in Unexamined Japanese Patent Publication No. 5-185858.

In an ordinary roller bearing, one of inner and outer rings has a rib with a rib face in sliding contact with a roller end face of each roller, which sliding contact accompanies a large slippage. Thus, if lubrication oil supplied to the bearing is lacking, seizure may possibly be caused at the joint between the rib face and the roller end face. For example, in the above-described differential, seizure may possibly be caused at the joint between the rib face and the roller end face when the lubrication oil stored in the differential casing is subjected to a centrifugal force and held at a limited portion within the differential casing, thereby causing the roller bearing to lack lubrication oil or when the temperature of the roller bearing becomes so high at rapid acceleration.

In order to prevent seizure at the joint between the rib face and the roller end face, there have been proposed a method of making the mating surfaces higher in the smoothness and flatness for thereby eliminating metal-to-metal contact as much as possible, as disclosed in Unexamined Japanese Patent Publication No. 2001-187916, and a method of forming a nitride layer on the surface of high chrome steel for thereby suppressing a rise in the frictional coefficient.

### SUMMARY OF THE INVENTION

The above-described method of preventing seizure by making the mating surfaces higher in the smoothness and flatness can prevent instantaneous metal-to-metal contact at the joint between the rib face and the roller end face. However, in case the roller bearing is used in transmission oil or gear oil added with a relatively large amount of additives such as zinc dithiophosphates (ZDTPs), corrosion wear occurs more than adhesion. In contrast to this, in case the roller bearing is used in a toroidal CVT and in traction oil added with a relatively small amount of additives, adhesion wear occurs more than corrosion wear and metal-to-metal contact at the joint between the rib face and the roller end face occurs each time the roller bearing alternates between a high speed operation and a low speed operation. Thus, the rib face and the roller end face are inevitably roughened and seizure is likely to be caused at the joint between the rib face and the roller end face. The above-described method is therefore insufficient in preventing the seizure.

For example, in toroidal CVT wherein a transmission ratio is varied continuously by varying the inclinations of power rollers, there occurs in the roller bearing that support the inner and outer rings of each power roller one upon another and is used in traction oil, a sharp rise in the frictional coefficient or an increase in the starting torque due to exhaustion or lack of traction oil.

Further, the above-described method of forming a nitride layer on the surface of a high chrome steel for thereby preventing the seizure at the joint between the rib face and the roller end face encounters a problem that not only it is required to change the materials of the inner and outer rings and/or rollers but it is difficult to form a stable nitride layer thereon since an oxidized Cr layer is liable to be formed when a nitriding process is carried out in an usual atmosphere.

It is accordingly an object of the present invention to provide a roller bearing that does not require a change of the materials and a particular heat treatment but can attain a sufficient anti-seizure property at the joint between a rib face of a ring and a roller end face of each roller even when lubrication oil is lacking or the roller bearing is used in traction oil of a small amount of additives, and therefore can attain a long life.

To achieve the above object, there is provided according to an aspect of the present invention a roller bearing comprising a pair of inner and outer rings at least one of which has a rib with a rib face, and a plurality of rollers interposed between the inner and outer rings and each having a roller end face in sliding contact with the rib face, wherein at least one of the rib and the roller end face has a surface hardness HV of 750 or more.

According to another aspect of the present invention, there is provided a roller bearing comprising a pair of inner and outer rings at least one of which has a rib with a rib face, and a plurality of rollers interposed between the inner and outer rings and each having a roller end face in sliding contact with the rib face, wherein at least one of the rib face and the roller end face is coated with a chemical conversion coating layer of an average grain size of 10 μm or less.

### BRIEF DESCRIPTION OF THE DRAWING

FIG. 1 is a schematic view of a toroidal CVT with a power roller in which a roller bearing according to the present invention is incorporated;

FIG. 2A is an enlarged sectional view of the power roller of FIG. 1; and

FIG. 2B is a plan view of a cage of the power roller of FIG. 1.

### DESCRIPTION OF THE PREFERRED EMBODIMENTS

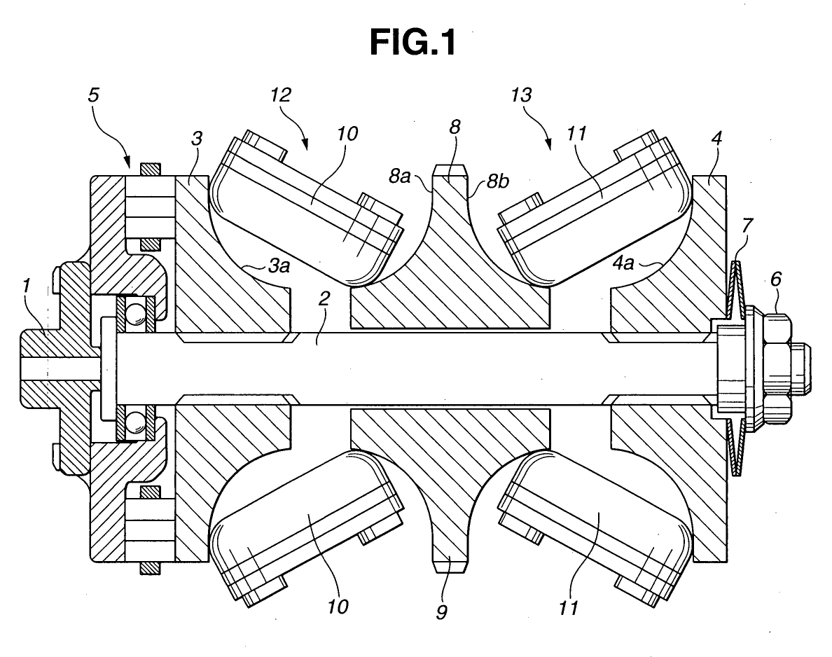

FIG. 1 shows a toroidal CVT with a power roller in which a roller bearing according to an embodiment of the present invention is incorporated. In the toroidal CVT, a driving power from an engine is transmitted to input shaft 1 by way of a torque converter (not shown) and a forward and backward movement switching mechanism (also not shown). Coaxially with input shaft 1 is disposed torque transmission shaft 2. To the opposite ends of torque transmission shaft 2 are splined so as to be movable axially thereof first input disk 3 and second input disk 4. Output disk 8 is disposed between first input disk 3 and second input disk 4 and rotatably mounted on transmission shaft 2.

Between the back surface of first input disk 3 and input shaft 1 is interposed loading cam mechanism 5 that generates an axial thrust force in accordance with an input torque. Further, between the back surface of second input disk 4 and nut 6 threadedly engaged with an end portion of torque transmission shaft 2 is interposed Belleville spring 7 that applies a preload to both input disks 3, 4.

Output disk 8 is made up of two output disk portions that are joined together to constitute an integral unit and has an outer peripheral portion formed with output gear 9. First input disk 3 and output disk 8 have at the surfaces facing or opposed to each other toroidal grooves 3a, 8a, respectively, and second input disk 4 and output disk 8 have at the surfaces facing or opposed to each other toroidal grooves 4a, 8b, respectively.

Between the toroidal grooves 3a, 8a and at the upper and lower sides thereof in the figure are disposed two first power rollers 10, 10 so as to be capable of transmitting a power therebetween by means of an oil film shearing force. Similarly, between toroidal grooves 4a, 8b are disposed two second power rollers 11, 11. First input disk 3, output disk 8 and first power rollers 10, 10 constitute first toroidal gearshift portion 12. Second input disk 4, output disk 8 and second power roller 11, 11 constitute second toroidal gearshift portion 13.

In the toroidal CVT structured as above, rotation of input shaft 1 is transmitted to respective input disks 3, 4 through torque transmission shaft 2. Rotation of input disks 3, 4 is then transmitted to output disk 8 by way of power rollers 10, 11. At the time of transmission of rotation from input disks 3, 4 to output disk 8, power rollers 10, 11 are simultaneously varied in inclination for thereby varying the transmission ratio continuously.

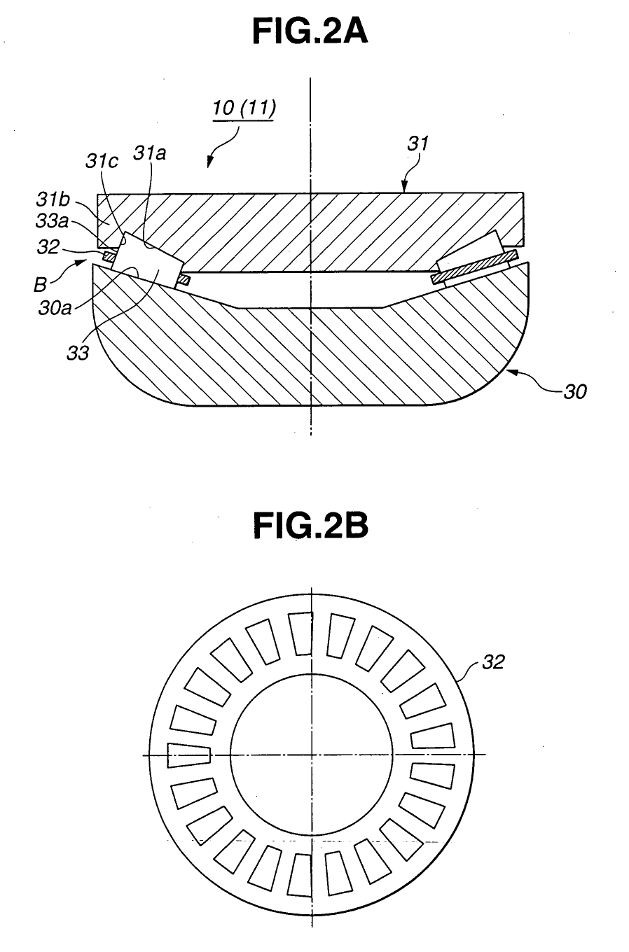

As shown in FIG. 2A, power roller 10 or 11 includes inner race or ring 30 in contact with input disk 3 or 4 and output disk 8, outer race or ring 31 disposed axially opposite to inner ring 30 and a plurality of tapered rollers 33 interposed between inner and outer rings 30 and 31 together with cage 32 shown in FIG. 2B. Namely, power roller 10 actually constitutes tapered roller bearing B consisting of inner ring 30, outer ring 31, cage 32 and tapered rollers 33. In the meantime, power roller 10 or 11, though not shown, includes a trunnion that is tiltable about an axis of tilting and has a pivot shaft on which inner ring 30 and outer ring 31 are rotatably mounted.

In tapered roller bearing B, inner ring 30 is formed with raceway surface 30a in rolling contact with tapered rollers 33. In contrast, outer ring 31 is formed with raceway surface 31a in rolling contact with tapered rollers 33 and annular rib 31b having rib face 31c in sliding contact with roller end faces 33a of tapered rollers 33, which roller end faces 33a are radially outer roller end faces located opposite to radially inner roller end faces (no numeral), i.e., located more on the outer peripheral side of bearing B. In the meantime, power roller 10 is not provided with a radial bearing for supporting a radial load that acts upon inner race 30 but all of a load and a thrust load that act upon inner race 30 is entirely supported by tapered roller bearings B.

In the above-described toroidal CVT, tapered roller bearing B of power roller 10 is used in traction oil (i.e., under lubrication by traction oil) and there may occur such a case wherein metal-to-metal contact at the joint between rib face 31c and roller end face 33a occurs each time tapered roller bearing B alternates between a high speed operation and a low speed operation and rib face 31c and roller end face 33a are roughened particularly in case tapered roller bearing B is used in traction oil added with a relatively small amount of additives. Such roughened rib face 31c and roller end face 33a may possibly cause seizure when traction oil is lacking or the temperature of traction oil is so high, or may possible cause a rise in a frictional coefficient or an increase in a starting torque and therefore a decrease in an acceleration ability when irregularities or undulations are caused in rib face 31c and roller end face 33a or rib face 31c and roller end face 33a are large in a friction drag.

Thus, in tapered roller bearing B described as above, at least one of rib face 31c and roller end face 33a is adapted to have a surface hardness HV (Vickers Hardness) of 750 or more and more preferably 800 or more. To attain such a hardness, one of a hard coating layer such as diamond-like carbon (DLC), CrN, WC/C and TiN, a nitride layer, and a hard plating layer such as Ni—P—SiC plating and hard chrome plating is formed on one of rib face 31c and roller end face 33a. Preferably, the thickness of the hard coating layer is in the range from 0.5 to 5 μm, the thickness of the nitride layer is in the range from 3 to 10 μm and the thickness of the hard plating layer is in the range from 5 to 30 μm. More preferably, the hard chrome plating layer is amorphous. Further more. preferably, the coating layer or plating layer has a surface roughness Ra of 0.3 μm or less.

By this, tapered roller bearing B can attain a good durability even if metal-to-metal contact at the joint between rib face 31c and roller end face 33a is caused by skew of rollers 33 or the like when tapered roller bearing B is operated in traction oil so as to alternate between a high speed operation and a low speed operation. This is because rib face 31c and roller end face 33a are hard to wear and flat and smooth so as to be hard to be roughened. Further, generation of frictional heat can be suppressed, and a sufficient anti-seizure property can be attained at the joint between rib face 31c and roller end face 33a even when traction oil is lacking. Further, a secular change of the surface roughness and smoothness of rib face 31c and roller end face 33a is small.

Further, a surface improving layer of a high hardness, i.e., a hard plating layer such as diamond-like carbon (DLC), CrN, WC/C and TiN or a hard plating layer such as Ni—P—SiC plating and hard chrome plating, is higher or lower in thermal conductivity as compared with iron. Thus, generation of frictional heat can be suppressed and the starting torque can be small. This enables to attain an elongated life of raceway surfaces of tapered roller bearing B, i.e., raceway surface 30a of inner ring 30 and raceway surface 31a of outer ring 31, thus making it possible to attain an elongated life of tapered roller bearing B and therefore an elongated life of power roller 10 or 11 using tapered roller bearing B and of the toroidal CVT.

Further, the hard chrome plating enables to attain a surface that is industrially cheap and has a high hardness. Since the hard chrome plating is quite low in surface energy, generation of frictional heat can be suppressed and the starting torque can be small. This enables to attain an elongated life of the raceway surfaces of tapered roller bearing B, i.e., raceway surface 30a of inner race 30 and raceway surface 31a of outer race 31, thus making it possible to attain an elongated life of tapered roller bearing B and therefore an elongated life of power roller 10 or 11 using tapered roller bearing B and of the toroidal CVT.

Further, in tapered roller bearing of this invention, a chemical conversion treatment layer of an average grain size of 10 μm or less and having a good running-in assisting property (i.e., a property of assisting running-in of mating surfaces) is formed on at least one of rib face 31c and roller end face 33a.

By this, even if rib face 31c and roller end face 33a are brought into metal-to-metal contact due to skew of rollers 33 that is caused when tapered roller bearing B is operated in traction oil so as to alternate between a high speed operation and a low speed operation, such metal-to-metal contact causes rib face 31c and roller end face 33a to run-in so as to become flat and smooth and therefore hard to become rough. Thus, generation of frictional heat is suppressed, the starting torque is low and the acceleration ability is not deteriorated. Further, a sufficient anti-seizure property can be attained at the joint between rib 31b and roller end face 33a even when the supply of traction oil is lacking.

Further, as described above, a chemical conversion coating layer such as manganese phosphate, zinc phosphate and iron phosphate, preferably of a thickness ranging from 1 to 10 μm is formed so as to assist running-in of rib face 31c and roller end face 33a and thereby make the surface roughness thereof smaller. This can elongate the life of raceway surfaces 30a, 31a of tapered roller bearing B and therefore the life of tapered roller bearing B, thus contributing to an elongated life of a toroidal CVT with power rollers 10, 11 having tapered roller bearings B.

### EXAMPLES

Examples of tapered roller bearing B of the present invention will now be described together with comparative examples.

### Example 1

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.03 μm. Thereafter, on outer ring 31 was formed by a chemical vapor deposition (CVD) method a diamond-like carbon (DLC) layer of the thickness of about 1 μm. In the meantime, the chemical vapor deposition method was performed at the temperature of 200° C. Further, rollers 33 as shown in FIG. 2A were formed from SUJ2 and subjected to refining (heating at 850° C. for one hour and quenching in oil of 60 ° C.) and tempering (heating at 160 ° C. for two hours). Then, rollers 33 were finished by grinding to the surface roughness Ra of about 0.03 μm.

### Example 2

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of 0.01 μm. Thereafter, on outer ring 31 was formed by a physical vapor deposition (PVD) method a diamond-like carbon (DLC) layer of the thickness of about 0.5 μm. In the meantime, the physical vapor deposition method was performed at the temperature of 200° C. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 3

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of 0.01 μm. Thereafter, on outer ring 31 was formed by a chemical vapor deposition (CVD) method a diamond-like carbon (DLC) layer of the thickness of about 3 μm. In the meantime, the chemical vapor deposition method was performed at the temperature of 200° C. Then, only rib face 31c of outer ring 31 was finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 4

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed by a physical vapor deposition (PVD) method a CrN layer of the thickness of about 5 μm. In the meantime, the chemical vapor deposition method was performed at the temperature of 250° C. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 5

Inner and outer rings 30, 31 as shown in FIG. 2A were formed from SCM435, i.e., chromium molybdenum steel prescribed in JIS G4105 and subjected to a carburizing treatment (carburizing at 920° C. for eight hours and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed by a physical vapor deposition (PVD) method a TiN layer of the thickness of about 2 μm. In the meantime, the physical vapor deposition method was carried out at the temperature of 450° C. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 6

Inner and outer rings 30, 31 as shown in FIG. 2A were formed from SCM435, i.e., chromium molybdenum steel prescribed in JIS G4105 and subjected to an ion nitriding treatment (nitriding in an nitrogen atmosphere of 20% N₂, 500° C. and 5 Torr for four hours and then gas cooling) and thereby formed with a nitride layer of the thickness of about 5 μm. Thereafter, only the surface of rib face 31c of outer ring 31 was finished by grinding to the surface roughness Ra of about 0.0 μ1 m. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 7

Inner and outer rings 30, 31 as shown in FIG. 2A were formed From SUJ2, i.e., high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed by a physical vapor deposition (PVD) method a diamond-like carbon (DLC) layer of the thickness of about 1 μm. In the meantime, the physical vapor deposition method was carried out at the temperature of 200° C. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm. Thereafter, on each roller 33 was formed by a physical vapor deposition (PVD) method a diamond-like carbon (DLC) layer of the thickness of about 1 μm. In the meantime, the physical vapor deposition method was carried out at the temperature of 200° C.

### Example 8

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed by a physical vapor deposition (PVD) method a WC/W layer of the thickness of about 1 μm. In the meantime, the physical vapor deposition method was performed at the temperature of 200° C. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 9

Inner and outer rings 30, 31 as shown in FIG. 2A were formed from SUJ2, i.e., high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed by a physical vapor deposition (PVD) method a diamond-like carbon (DLC) layer of the thickness of about 0.3 μm. In the meantime, the physical vapor deposition method was performed at the temperature of 200° C. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 10

Inner and outer rings 30, 31 as shown in FIG. 2A were formed from SCM435, i.e., chromium molybdenum steel prescribed in JIS G4105 and subjected to an ion nitriding treatment (nitriding in an nitrogen atmosphere of 20% N₂, 500° C. and 5 Torr for 50 minutes and then gas cooling) and thereby formed with a nitride layer of the thickness of about 2 μm. Then, inner and outer rings 30, 31 were finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 11

Inner and outer rings 30, 31 as shown in FIG. 2A were formed from SUJ2, i.e., high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of 0.01 μm. Thereafter, inner and outer rings 30, 31 were subjected to a non-electrolytic Ni—P—SiC plating process and a heat treatment (heating at 400° C. for one hour) and thereby coated with a Ni—P—SiC plating layer of the thickness of about 3 μm. Thereafter, only rib face 31c of outer ring 31 was finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 12

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm. Thereafter, rollers 33 were subjected to a non-electrolytic Ni—P—SiC composite plating process and a heat treatment (heating at 400° C. for one hour) and thereby coated with a Ni—P—SiC plating layer of the thickness of about 3 μm. Thereafter, only roller end faces 33a were finished by grinding to the surface roughness Ra of about 0.01 μm.

### Example 13

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of 0.01 μm. Thereafter, on outer ring 31 was formed by a chemical vapor deposition (CVD) method a diamond-like carbon (DLC) layer of the thickness of about 6 μm. In the meantime, the chemical vapor deposition method was carried out at the temperature of 200° C. Then, only rib face 31c of outer ring 31 was finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 14

Inner and outer rings 30, 31 as shown in FIG. 2A were formed from SCM435, i.e., a chromium molybdenum steel prescribed in JIS G4105 and subjected to an ion nitriding treatment (nitriding in a nitrogen atmosphere of 80% N₂, 500° C. and 5 Torr for ten hours and gas cooling), then finished by grinding to the surface roughness Ra of about 0.01 μm and thereby formed with a nitride layer of the thickness of about 12 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 15

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, inner and outer rings 30, 31 were subjected to an electrolytic plating process that was carried out in a plating bath containing chromic acid and formic acid, at 50° C. and under a current density of 80 A/dm² and coated with a non-amorphous hard chrome plating layer of the thickness of about 10 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 16

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, inner and outer rings 30, 31 were subjected to an electrolytic plating process that was carried out in a plating bath containing chromic acid and formic acid, at 25° C. and under a current density of 50 A/dm², then subjected to a heat treatment (heating at 300° C. for one hour), thereafter finished by grinding to the surface roughness Ra of about 0.01 μm and thereby coated with an amorphous hard chrome plating layer of the thickness of about 10 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 17

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Thereafter, rollers 33 were subjected to an electrolytic plating process that was carried out in a plating bath containing chromic acid and formic acid, at 25° C. and under a current density of 50 A/dm², then subjected to a heat treatment (heating at 300° C. for one hour), thereafter finished by grinding to the surface roughness Ra of about 0.01 μm and thereby coated with an amorphous hard chrome plating layer of the thickness of about 2 μm.

### Example 18

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, inner and outer rings 30, 31 were subjected to an electrolytic plating process that was carried out in a plating bath containing chromic acid and formic acid, at 30° C. and under a current density of 20 A/dm², then subjected to a heat treatment (heating at 300° C. for one hour), thereafter finished by grinding to the surface roughness Ra of about 0.01 μm and thereby coated with an amorphous hard chrome plating layer of the thickness of about 35 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 19

Inner and outer rings 30, 31 as shown in FIG. 2A were formed from SCM435, i.e., chromium molybdenum steel prescribed in JIS G4105 and subjected to an ion nitriding treatment (nitriding in an nitrogen atmosphere of 20% N₂, 500° C. and 5 Torr for four hours and then gas cooling), then finished by grinding to the surface roughness Ra of about 0.04 μm and thereby formed with a nitride layer of the thickness of about 2 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.04 μm.

### Comparative Example 1

Inner and outer rings 30, 31 and rollers 33 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 and rollers 33 were finished by grinding to the surface roughness Ra of about 0.04 μm.

### Comparative Example 2

Inner and outer rings 30, 31 and rollers 33 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 and rollers 33 were finished by grinding to the surface roughness Ra of about 0.01 μm

### Comparative Example 3

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of 0.01 μm. Thereafter, inner and outer rings 30, 31 were subjected to a non-electrolytic Ni—P-graphite composite plating process and a heat treatment (heating at 400° C. for one hour), then finished by grinding to the surface roughness Ra of about 0.01 μm and thereby coated with a Ni—P-graphite plating layer of the thickness of about 20 μm. Thereafter, only rib face 31c of outer ring 31 was finished by grinding to the surface roughness of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Comparative Example 4

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Thereafter, rollers 33 were subjected to a non-electrolytic Ni—P-graphite composite plating process and a heat treatment (heating at 400° C. for one hour), then finished by grinding to the surface roughness Ra of about 0.01 μm and thereby coated with a Ni—P-graphite plating layer of the thickness of about 10μm. Thereafter, only roller end faces 33a were finished by grinding to the surface roughness Ra of about 0.01 μm.

The result of measurement of the surface hardness (measurement being made by using a Vickers hardness tester of 50 g) and the surface roughness of each of the above-described examples 1 to 19 and comparative examples 1 to 4 were shown in Table 1 together with the specification (material and surface improving layer) thereof. Further, each of the examples and comparative examples was subjected to a tapered roller bearing test under the conditions shown in Table 2 to evaluate the anti-seizure property and a tapered roller bearing test under the condition shown in Table 3 to search a number of repetition of cumulative stress and form a Weibull distribution thereby finding L50 life. Further, a starting torque was measured under the condition shown in Table 4. The test results were also shown in Table 1.

As is apparent from the test results shown in Table 1, tapered roller bearings B according to the Examples 1 to 19 of the invention were low in the starting toque and excellent in the anti-seizure property at the joint between rib face 31c and roller end face 33a. Thus, it is confirmed that tapered roller bearings B according to examples 1 to 19 of this invention have a long life.

Namely, in examples 1 to 18, at least one of rib face 31c and roller end face 33a has a surface hardness HV of 800 or more and a surface roughness Ra of 0.01 μm or less. Thus, even if there occurs such a condition in which lubrication oil is lacking or the thickness of oil film becomes thin, rib face 31c and roller end face 33a are hard to become rough and generation of frictional heat is suppressed. This enables tapered roller bearing B to be low in the starting toque and have a considerably improved anti-seizure property. Further, since generation of frictional heat at raceway surfaces 30a, 31a is suppressed, tapered roller bearing B is improved in the rolling fatigue strength.

TABLE 1

| | | Inner and outer rings | | | | | Roller | | | | | | | |
|---|---|---|---|---|---|---|---|---|---|---|---|---|---|---|
| | | | | | Surface | | | | | Surface | | Anti- | | |
| | Ex- | | | Surface | hard- | | | | Surface | hardness | | seizure | L50 | |
| | am- | | Surface | rough- | ness | Thick- | Mate- | Surface | rough- | HV | Thick- | property | time | Starting |
| | ple | Material | improving | ness | HV | ness | rial | Improving | ness | (0.05) | ness | (Time | (Time | torque |
| | No. | (JIS) | layer | Ra | (0.05) | μm | (JIS) | layer | Ra | HV | μm | ratio) | ratio) | Nm |
| In- | 1 | SUJ2 | DLC | 0.03 | 2886 | 1 | SUJ2 | No | 0.03 | 715 | — | 8.9 | 4.2 | 12 |
| ven- | 2 | SUJ2 | DLC | 0.01 | 3053 | 0.5 | SUJ2 | No | 0.01 | 719 | — | 9.2 | 4.8 | 10 |
| tion | 3 | SUJ2 | DLC | 0.01 | 2998 | 3 | SUJ2 | No | 0.01 | 721 | — | 11.9 | 5.7 | 9 |
| | 4 | SUJ2 | CrN | 0.01 | 1681 | 5 | SUJ2 | No | 0.01 | 715 | — | 8.8 | 4.1 | 15 |
| | 5 | SCM435 | TiN | 0.01 | 2250 | 2 | SUJ2 | No | 0.01 | 725 | — | 8.3 | 3.9 | 16 |
| | 6 | SCM435 | Nitride | 0.01 | 985 | 5 | SUJ2 | No | 0.01 | 628 | — | 8.1 | 3.3 | 19 |
| | 7 | SUJ2 | DLC | 0.01 | 3065 | 1 | SUJ2 | DLC | 0.01 | 2958 | 1 | 13.5 | 6.8 | 11 |
| | 8 | SUJ2 | WC/C | 0.01 | 1720 | 1 | SUJ2 | No | 0.01 | 721 | — | 8.5 | 4.4 | 12 |
| | 9 | SUJ2 | DLC | 0.01 | 2983 | 0.3 | SUJ2 | No | 0.01 | 722 | — | 6.5 | 3.4 | 10 |
| | 10 | SCM435 | Nitride | 0.01 | 985 | 2 | SUJ2 | No | 0.01 | 722 | — | 5.4 | 3.2 | 20 |
| | 11 | SUJ2 | Ni-P-SiC | 0.01 | 1880 | 3 | SUJ2 | No | 0.01 | 722 | — | 9 | 4.5 | 18 |
| | | | plating | | | | | | | | | | | |
| | 12 | SUJ2 | No | 0.01 | 722 | — | SUJ2 | Ni-P-SiC | 0.01 | 1882 | 3 | 5.2 | 3.1 | 19 |
| | | | | | | | | plating | | | | | | |
| | 13 | SUJ2 | DLC | 0.01 | 2957 | 6 | SUJ2 | No | 0.03 | 718 | — | 9 | 2.8 | 11 |
| | 14 | SCM435 | Nitride | 0.01 | 985 | 12 | SUJ2 | No | 0.03 | 722 | — | 7.9 | 2.3 | 20 |
| | 15 | SUJ2 | Hard | 0.01 | 995 | 10 | SUJ2 | No | 0.01 | 715 | — | 9.1 | 4.7 | 10 |
| | | | Cr-plating | | | | | | | | | | | |
| | | | (Non- | | | | | | | | | | | |
| | | | amorphous) | | | | | | | | | | | |
| | 16 | SUJ2 | Hard | 0.01 | 1540 | 10 | SUJ2 | No | 0.01 | 718 | — | 8.8 | 4.5 | 11 |
| | | | Cr-plating | | | | | | | | | | | |
| | | | (Amorphous) | | | | | | | | | | | |
| | 17 | SUJ2 | No | 0.01 | 725 | — | SUJ2 | Hard | 0.01 | 1580 | 10 | 8.9 | 4.8 | 12 |
| | | | | | | | | Cr-plating | | | | | | |
| | | | | | | | | (Amorphous) | | | | | | |
| | 18 | SUJ2 | Hard | 0.01 | 1540 | 35 | SUJ2 | No | 0.01 | 718 | — | 3.5 | 3.4 | 19 |
| | | | Cr-plating | | | | | | | | | | | |
| | | | (Amorphous) | | | | | | | | | | | |
| | 19 | SCM435 | Nitride | 0.04 | 973 | 2 | SUJ2 | No | 0.04 | 720 | — | 4.5 | 3.1 | 20 |
| Com- | 1 | SUJ2 | No | 0.04 | 728 | — | SUJ2 | No | 0.04 | 732 | | 1 | 1 | 28 |
| par- | 2 | SUJ2 | No | 0.01 | 741 | — | SUJ2 | No | 0.01 | 745 | | 1.9 | 1.2 | 25 |
| ative | 3 | SUJ2 | Ni-P- | 0.01 | 785 | 20 | SUJ2 | No | 0.01 | 709 | — | 2.9 | 2.4 | 21 |
| ex- | | | graphite | | | | | | | | | | | |
| am- | | | plating | | | | | | | | | | | |
| ple | 4 | SUJ2 | No | 0.01 | 709 | — | SUJ2 | Ni-P- | 0.01 | 785 | 10 | 2.8 | 2.2 | 22 |
| | | | | | | | | graphite | | | | | | |
| | | | | | | | | plating | | | | | | |

TABLE 2
Anti-seizure property test

| | |
|---|---|
| Load | 120 kN |
| Rotation speed | 6000 rpm |
| Lube oil | Traction oil |
| Supply amount of lube | 0.5 L/min |
| oil before supply of | |
| lube oil is stopped | |
| Oil temperature | 80° C. |

TABLE 3
Life test

| | |
|---|---|
| Load | 60 kN |
| Rotation speed | 6000 rpm |
| Lube oil | Traction oil |
| Supply amount of lube | 5 L/min |
| oil | |
| Oil temperature | 120° C. |

TABLE 4
Measurement of starting torque

| | |
|---|---|
| Load | 60 kN |
| Rotation speed | 0 rpm |
| Lube oil | Traction oil |
| Supply amount of lube | 5 L/min |
| oil | |
| Oil temperature | 120° C. |

Further, in case of a combination of the surface hardness HV of one of rib face 31c and roller end face 33a being 800 or more and the- surface roughness Ra being about 0.01 μm as in examples 2 to 18, generation of friction heat at raceway surfaces 30a, 31a is suppressed so that tapered roller bearing B is further more improved in the starting torque and the anti-seizure property and also improved in the rolling fatigue strength of raceway surfaces 30a, 31a.

Further, also in the case, as in examples 12 and 17, roller end face 33a has a surface hardness HV of 800 or more and a surface roughness Ra of about 0.01 μm as in examples 12 and 17, generation of frictional heat is decreased so that tapered roller bearing B is improved in the starting toque and the anti-seizure property and also in the rolling fatigue strength of raceway surfaces 30a, 31a.

Further, in case, as in example 7, both rib face 31c and roller end face 33a have a surface hardness HV of 800 or more and a surface roughness Ra of about 0.01 μm, generation of frictional heat is decreased so that tapered roller bearing B is improved in the starting toque and the anti-seizure property and also in the rolling fatigue strength of raceway surfaces 30a, 31a.

Further, in case, as in example 9, the thickness of the diamond-like carbon (DLC) layer is less than 0.5 μm though rib face 31c has a surface hardness HV of 800 or more and a surface roughness Ra of about 0.01 μm, generation of frictional heat is decreased and the anti-seizure property at the joint between rib face 31c and roller end face 33a is improved but since the diamond-like carbon (DLC) layer is thin, it is peeled off after long time of usage so that the life of raceway surfaces 30a, 31a is not sufficiently long.

Further, in case, as in example 10, the thickness of the nitride layer is less than 3 μm though rib face 31c has a surface hardness HV of 800 or more and a surface roughness Ra of about 0.01 μm, generation of frictional heat is decreased and the anti-seizure property at the joint between rib face 31c and roller end face 33a is improved but since the nitride layer is thin, it wears off after a long time of usage so that the life of raceway surfaces 30a, 31a is not sufficiently long.

Further, in case, as in example 11, the thickness of the Ni—P—SiC plating layer is less than 5 μm though rib face 31c has a surface hardness HV of 800 or more and a surface roughness Ra of about 0.01 μm, generation of frictional heat is decreased and the anti-seizure property at the joint between rib 31b and the end surface of roller 33 is improved but since the Ni—P—SiC plating layer is thin, it wears off after a long time of usage so that the life of raceway surfaces 30a, 31a is not sufficiently long.

Further, in case, as in example 13, the thickness of the diamond-like carbon (DLC) layer is larger than 5 μm though rib face 31c has a surface hardness HV of 800 or more and a surface roughness Ra of about 0.01 μm, generation of frictional heat is decreased and the anti-seizure property at the joint between rib face 31c and roller end face 33a is improved but since the stress inside the diamond-like carbon (DLC) layer increases with increase in the thickness of the layer, peeling off inside the layer is likely to be caused so that the life of raceway surfaces 30a, 31a is not sufficiently long.

Further, in case, as in examples 16, 17, the heat treatment was carried out after formation of the amorphous chromium plating layer, the surface hardness HV of rib face 31c or roller end face 33s becomes so high, i.e., 1000 or more, as compared with the non-amorphous chromium plating layer of example 15. In addition, since rib face 31c and roller end face 33a have a surface roughness Ra of about 0.01 μm, generation of frictional heat is decreased and improvement in the starting torque and the anti-seizure property can be attained.

Further, in case, as in example 14, the thickness of the nitride layer is larger than 10 μm though the surface hardness HV of rib face 31c is larger than 800 and a surface roughness Ra is about 0.01 μm, generation of frictional heat is decreased and the anti-seizure property at the joint between rib face 31c and roller end face 33a is improved but since a crack or cracks inside the nitride layer are more likely to occur to allow the nitride layer to be peeled off as the nitride layer becomes thicker, the life of raceway surfaces 30a, 31a is not sufficiently long.

Further, in case, as in example 18, the thickness of the surface improving layer such as the hard chrome plating layer is larger than 30 μm though the surface hardness HV of rib face 31c is larger than 800 and a surface roughness Ra of about 0.01 μm, rollers 33 and inner and outer rings 30, 31 are likely to be displaced out of position to cause partial contact thereof. Thus, generation of frictional heat and the starting torque tend to increase so that the anti-seizure property at the joint between rib face 31c and roller end face 33a is not sufficient and the life of raceway surfaces 30a, 31a is not long enough.

Further, in case, as in Example 19, the surface roughness is 0.04 μm though rib face 31c has a surface hardness HV of 800 or more, generation of frictional heat is increased so that the starting torque is not small enough, the anti-seizure property at the joint between rib face 31c and roller end face 33a is not sufficient and the life of raceway surfaces 30a, 31a is not long enough.

As compared with the above-described examples 1 to 19, in case, as in comparative example 1, the surface roughness Ra of rib face 31c and roller end face 33a is relatively large, i.e., 0.04 μm and the surface hardness HV is less than 800, generation of frictional heat is increased so that seizure is caused in an early stage of usage, the starting toque is increased and peeling off at raceway surfaces 30a, 31a is caused in an early stage of usage.

Further, in case, as in comparative example 2, the surface hardness HV of rib face 31c and roller end face 33a is less than 800 and the surface roughness Ra is about 0.01 μm, the starting toque is not small enough and the anti-seizure property is not sufficient.

Further, in case, as in comparative examples 3 and 4, the surface hardness HV of rib face 31c and roller end face 33a is less than 800 and the surface roughness Ra is about 0.01 μm, the starting torque is not small enough, and the anti-seizure property and the rolling fatigue life are not sufficient.

In the meantime, in the above-described examples 1 to 19, the hard coating layer such as diamond-like carbon, CrN, WC/C and TiN, etc., the nitride layer, the Ni—P—SiC plating layer and the hard chrome plating layer have been described as the surface improving layer, the surface improving layer is not limited to those described as above but can be another layer so long as it has a surface hardness HV of 750 or more or preferably 800 or more. Further, by a masking technique, the surface improving layer can be formed only at necessary portions of rollers 33 and inner and outer rings 30, 31 so as to obtain the same effect, namely, the portions or places where the surface improving layer is formed are not limited.

### Example 20

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed a manganese phosphate coating layer (dipping in a conversion treatment solution of 70° C. for five minutes) as a surface improving layer. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 21

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed a zinc phosphate coating layer (dipping in a conversion treatment solution of 40° C. for 3 minutes) as a surface improving layer. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 22

Inner and outer rings 30, 31 as shown in FIG. 2A were formed from SUJ2, i.e., a high carbon chromium bearing steel prescribed in JIS G4805 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, on outer ring 31 was formed an iron phosphate coating layer (dipping in a conversion treatment solution of 40° C. for three minutes) as a surface improving layer. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm.

### Example 23

Inner and outer rings 30, 31 as shown in FIG. 2A were formed from SUJ2, i.e., a high carbon chromium bearing steel prescribed in JIS G4805 and subjected to carburizing (carburizing at 920° C. for eight hours and quenching in oil of 60° C.) and tempering (heating at 160° C. for two hours). Then, inner and outer rings 30, 31 were finished by grinding to the surface roughness Ra of about 0.01 μm. Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm and coated with a manganese phosphate coating layer (by dipping rollers 33 in a conversion treatment solution of 70° C. for 5 minutes) as a surface improving layer.

### Example 24

Inner and outer rings 30, 31 as shown in FIG. 2A were formed from SUJ2, i.e., a high carbon chromium bearing steel prescribed in JIS G4805 and subjected to carburizing (carburizing at 920° C. for eight hours and quenching in oil of 60° C.) and tempering (heating at 160° C. for two hours). Then, inner and outer rings 30, 31 were finished by grinding to the surface roughness Ra of about 0.01 μm. Thereafter, outer ring 31 is coated with a manganese phosphate coating layer (by outer ring 31 in a conversion treatment solution of 70° C. for five minutes). Further, rollers 33 as shown in FIG. 2A were formed from SUJ2 and subjected to refining (heating at 850° C. for one hour and quenching in oil of 60° C.) and tempering (heating at 160° C. for two hours). Then, rollers 33 were finished by grinding to the surface roughness Ra of about 0.01 μm and coated with a manganese phosphate coating layer (by dipping rollers 33 in a conversion treatment solution of 70° C. for 5 minutes) as a surface improving layer.

### Comparative Example 5

Similarly to the above-described comparative example 1, inner and outer rings 30, 31 and rollers 33 were formed from SUJ2 and subjected to refining (heating at 850° C. for one hour and quenching in oil of 60° C.) and tempering (heating at 160° C. for two hours). Then, inner and outer rings 30, 31 and rollers 33 were finished by grinding to the surface roughness Ra of about 0.04 μm.

### Comparative Example 6

Similarly to the above-described comparative example 2, inner and outer rings 30, 31 and rollers 33 were formed from SUJ2 and subjected to refining (heating at 850° C. for one hour and quenching in oil of 60° C.) and tempering (heating at 160° C. for two hours). Then, inner and outer rings 30, 31 and rollers 33 were finished by grinding to the surface roughness Ra of about 0.01 μm.

### Comparative Example 7

Inner and outer rings 30, 31 as shown in FIG. 2A were formed from SUJ2 and subjected to refining (heating at 850° C. for one hour and quenching in oil of 60° C.) and tempering (heating at 160° C. for two hours). Then, inner and outer rings 30, 31 were finished by grinding to the surface roughness Ra of about 0.01 μm. Thereafter, outer ring 31 was coated with a manganese phosphate coating layer (by dipping outer ring 31 in a conversion treatment solution of 80° C. for 10 minutes). Further, rollers 33 as shown in FIG. 2A were formed from SUJ2 and subjected to refining (heating at 850° C for one hour and quenching in oil of 60° C.) and tempering (heating at 160° C. for two hours). Then, rollers 33 were finished by grinding to the surface roughness Ra of about 0.04 μm.

The result of measurement of the average grain size and the thickness of the chemical conversion coating layer is shown in Table 6 together with the specification (relating to the chemical conversion coating layer) of tapered roller bearing B according to the above-described examples 20 to 24 and comparative examples 5 to 7. Further, the tapered roller bearing B according to each example was subjected to a running-in operation shown in Table 5 and the surface roughness was measured. The result of measurement of the surface roughness after the running-in operation is shown in Table 7. Further, after the running-in operation, the test for the anti-seizure property of the tapered roller bearing B was performed under the condition shown in Table 2, and the test for the life of tapered roller bearing B was carried out under the condition shown in Table 3. The tests were carried out to search a number of repetition of cumulative stress until peeling off of the raceway surfaces 30a, 31a of inner and outer rings 30, 31 occurred and form a Weibull distribution thereby finding L50 life. Further, the starting torque was measured under the condition shown in Table 4. The test results are shown in Table 7.

As is apparent from the test results shown in Table 7, tapered roller bearings B according to the examples 20 to 24 of this invention are low in the starting torque and excellent in the anti-seizure property at the joint between rib face 31c and roller end face 33a. From this, it is confirmed that tapered roller bearings B according to the examples 20 to 24 of this invention have a long life.

Namely, in the examples 20 to 23, at least one of rib face 31c and roller end face 33a is coated with a chemical conversion coating layer of the average grain size of 10 μm or less, i.e., a chemical conversion coating layer that is fine in the grain size so as to assist running-in of the mating surfaces of rib face 31c and roller end face 33a and attain the surface roughness Ra of 0.03 μm or less. Since the chemical conversion coating layer enables the mating surfaces of rib face 31c and roller end face 33a to run-in and become smooth and flat so as to attain a desired surface roughness in an initial period of usage, an effect of decreasing generation of frictional heat is enhanced, the starting torque is lowered and the anti-seizure property is improved. Further, raceway surfaces 30a, 31a are increased in the rolling fatigue strength by the effect of the improved surface roughness accompanied by the improvement in the running-in assisting property.

TABLE 5
Running-in operation

| | |
|---|---|
| Load | 60 kN |
| Rotation speed | 150 rpm |
| Lube oil | Traction oil |
| Supply amount of lube | 5 L/min |
| oil | |
| Oil temperature | 120° C. |
| Operation time | 5 min |

TABLE 6

| | | Inner and outer rings | | | | Roller | | | |
|---|---|---|---|---|---|---|---|---|---|
| | | | | Average | | | | Average | |
| | | | Chemical | grain | Layer | | Chemical | grain | Layer |
| | | Material | conversion | size | thickness | Material | conversion | size | thickness |
| Example No. | | (JIS) | coating layer | (μm) | (μm) | (JIS) | coating layer | (μm) | (μm) |
| Invention | 20 | SUJ2 | Manganese | 3 | 5 | SUJ2 | NO | NO | NO |
| | | | phosphate | | | | | | |
| | 21 | SUJ2 | Zinc | 5 | 8 | SUJ2 | NO | NO | NO |
| | | | phosphate | | | | | | |
| | 22 | SUJ2 | Iron | 9 | 10 | SUJ2 | NO | NO | NO |
| | | | phosphate | | | | | | |
| | 23 | SUJ2 | NO | NO | NO | SUJ2 | Manganese | 5 | 7 |
| | | | | | | | phosphate | | |
| | 24 | SUJ2 | Manganese | 2 | 4 | SUJ2 | Manganese | 2 | 4 |
| | | | phosphate | | | | phosphate | | |
| Comparative | 5 | SUJ2 | NO | NO | NO | SUJ2 | NO | NO | NO |
| example | 6 | SUJ2 | NO | NO | NO | SUJ2 | NO | NO | NO |
| | 7 | SUJ2 | Manganese | 20 | 25 | SUJ2 | NO | NO | NO |
| | | | phosphate | | | | | | |

TABLE 7

| | | Surface roughness (Ra) | | | | |
|---|---|---|---|---|---|---|
| | | after running-in | | | | |
| | | operation | | | | |
| | | | | Anti- | | |
| | | | | seizure | L50 | |
| | | | | property | life | Starting |
| Example | | Rib | Roller | (time | (time | torque |
| No. | | (μm) | (μm) | ratio) | ratio) | (Nm) |
| Invention | 20 | 0.03 | 0.01 | 5.4 | 3.9 | 19 |
| | 21 | 0.03 | 0.01 | 4.9 | 2.8 | 18 |
| | 22 | 0.03 | 0.01 | 4.2 | 2.5 | 19 |
| | 23 | 0.01 | 0.02 | 5.2 | 3.1 | 19 |
| | 24 | 0.03 | 0.02 | 7.1 | 4.3 | 20 |
| Comparative | 5 | 0.04 | 0.04 | 1 | 1 | 28 |
| example | 6 | 0.01 | 0.01 | 1.9 | 1.2 | 25 |
| | 7 | 0.04 | 0.04 | 2.5 | 1.1 | 22 |

Further, in case, as in the example 24, both of rib face 31c and roller end face 33a are coated with the chemical conversion coating layers, the mating surfaces run-in to improve the surface roughness and become smooth and flat, an effect of decreasing generation of frictional heat is enhanced, the starting torque is lowered and the anti-seizure property is further improved. Further, generation of frictional heat at raceway surfaces 30a, 31a is decreased so that the rolling fatigue strength of raceway surfaces 30a, 31a is increased.

In case, in contrast to the examples 20 to 24 and as in the comparative example 5, rib face 31c and roller end face 33a are not coated with any chemical conversion coating layer, generation of frictional heat is increased when the surface roughness Ra is relatively large, i.e., 0.04 μm, thus increasing the starting torque, causing seizure in an early stage of usage and also causing peeling off of raceway surfaces 30a, 31a in an early stage of usage.

Further, in case, as in the comparative example 6, rib face 31c and roller end face 33a are not provided with any chemical conversion coating layer and the surface roughness Ra is 0.01 μm, the starting toque is not small enough and the anti-seizure property is not sufficient though the rolling fatigue strength is improved.

Further, in case, as in the comparative example 7, rib face 31c is coated with the chemical conversion coating layer but the average grain size and the thickness exceed 10 μm, there exist, even after running-in of rib face 31c and roller end face 33a, large holes formed by corrosion at the time of formation of the coating layer and the surface roughness Ra is large, i.e., 0.0 μ4 m, thus increasing the frictional coefficient of rib face 31c. Thus, the anti-seizure property at the joint between rib face 31c and roller end face 33a is not sufficient and the life of raceway surfaces 30a, 31a is not sufficiently long. In the meantime, the chemical conversion coating layer of the thickness of 1 μm or less is not desirable since it deteriorates the effect of improving the surface roughness by running-in that is attained when the mating surfaces is brought into metal-to-metal contact.

While in the examples 20 to 24, a chemical conversion coating layer has been described as being made of one of manganese phosphate, zinc phosphate and iron phosphate, it is not limitative but can be replaced by any other coating layer so long as the coating layer has a good running-in assisting property. Further, by a masking technique, the chemical conversion coating layer can be formed only at necessary portions of rollers 33 and inner and outer rings 30, 31 so as to obtain the same effect, namely, the portions or places where the chemical conversion coating layer is formed are not limited.

The entire contents of Japanese Patent Application P2003-206425 (Aug. 7, 2003) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A roller bearing comprising:
a pair of rings at least one of which has a rib with a rib face; and
a plurality of rollers interposed between the rings and each having a roller end face in sliding contact with the rib face;
wherein at least one of the rib face and the roller end face has a surface hardness HV of 750 or more.

2. A roller bearing according to claim 1, wherein at least one of the rib face and the roller end face has a surface hardness HV of 800 or more.

3. A roller bearing according to claim 1, wherein at least one of the rib face and the roller end face is coated with a hard coating layer comprising one of a diamond-like carbon layer, a CrN layer, a WC/C layer and a TiN layer.

4. A roller bearing according to claim 3, wherein the thickness of the hard coating layer is in the range of 0.5 to 5 μm.

5. A roller bearing according to claim 1, wherein at least one of the rib face and the roller end face is formed with a nitride layer.

6. A roller bearing according to claim 5, wherein the thickness of the nitride layer is in the range of 3 to 10 μm.

7. A roller bearing according to claim 1, wherein at least one of the rib face and the roller end face is coated with a hard plating layer comprising one of a Ni—P—SiC plating layer and a hard chrome plating layer.

8. A roller bearing according to claim 7, wherein the thickness of the hard plating layer is in the range of 5 to 30 μm.

9. A roller bearing according to claim 7, wherein the hard chrome plating layer is amorphous.

10. A roller bearing according to claim 1, wherein the surface roughness Ra of the rib face and the roller end face is 0.03 μm or less.

11. A roller bearing according to claim 1, wherein at least one of the rib face and the roller end face is coated with one of a hard coating layer and a hard plating layer, the hard coating layer comprising one of a diamond-like carbon layer, a CrN layer, a WC/C layer and a TiN layer, the hard plating layer comprising one of a Ni—P—SiC plating layer and a hard chrome plating layer, and the surface roughness Ra of at least one of the rib face and the roller end face is 0.03 μm or less.

12. A roller bearing according to claim 1, wherein the rings and the rollers are used in traction oil.

13. A toroidal continuously variable transmission comprising a roller bearing including:
a pair of rings at least one of which has a rib with a rib face; and
a plurality of rollers interposed between the rings and each having a roller end face in sliding contact with the rib face;
wherein at least one of the rib face and the roller end face has a surface hardness HV of 750 or more.

14. A roller bearing comprising:
a pair of rings at least one of which has a rib with a rib face; and
a plurality of rollers interposed between the rings and each having a roller end face in sliding contact with the rib face;
wherein at least one of the rib face and the roller end face is coated with a chemical conversion coating layer of an average grain size of 10 μm or less.

15. A roller bearing according to claim 14, wherein the thickness of the chemical conversion coating layer is in the range of 1 to 10 μm.

16. A roller bearing according to claim 14, wherein the rings and the rollers are used in traction oil.

17. A toroidal continuously variable transmission comprising a roller bearing including:
a pair of rings at least one of which has a rib with a rib face; and
a plurality of rollers interposed between the rings and each having a roller end face in sliding contact with the rib face;
wherein at least one of the rib face and the roller end face is coated with a chemical conversion coating layer of an average grain size of 10 μm or less.
